(19) United States
(12) Patent Application Publication
(10) Pub. No.: US 2004/0012614 A1
(43) Pub. Date: Jan. 22, 2004

(54) Scaling apparatus and method

(75) Inventors: Woo-Sung Shim, Gyeonggi-do (KR); Jung-Wook Suh, Seoul (KR)

Correspondence Address: SUGHRUE MION, PLLC, 2100 PENNSYLVANIA AVENUE, N.W., WASHINGTON, DC, 20037, US

(73) Assignee: Samsung Electronics Co., Ltd.

(21) Appl. No.: 10/330,246

(22) Filed: Dec. 30, 2002

(30) Foreign Application Priority Data
Jul. 20, 2002 (KR) 2002-42761

(51) Int. Cl. G09G 5/00

(52) U.S. Cl. 345/660

(57) ABSTRACT

A scaling apparatus and method for zooming in or out a video or graphic window is provided. The scaling apparatus includes a source data input unit to which source data is input; a serial output unit serially outputting display data included in the source data; a scaling unit scaling the serially output display data according to a scaling ratio included in the source data; and a scaled display data output unit outputting the scaled display data. The scaling speed of the scaling apparatus is increased by processing an application for zooming in or out a video or graphic window in hardware. Further, the internal memory size of a scaler is reduced by serially scaling. In addition, scaling on desktop can be carried out under the mobile environment which is small and lightweight.

### BACKGROUND OF THE INVENTION

This application is based on and claims the priority from Korean Patent Application No. 2002-42761, filed Jul. 20, 2002, which is incorporated herein in its entirety by reference.

1. Field of the Invention

The present invention relates to an apparatus and method for processing an application for zooming in or out a video or graphic window in hardware, and more particularly, to a scaling apparatus and method for zooming in or out a video or graphic window under a mobile environment.

2. Description of the Related Art

Conventionally, when scaling in order to zoom in or out a window, all scaling processes are controlled by a central processing unit (CPU) by embodying the scaling in software. As a result, the performance of the CPU is lowered. Particularly, the conventional scaling apparatus using a parallel processing type scaler cannot cope with the present mobile environment in view of memory size and power consumption.

### SUMMARY OF THE INVENTION

To solve the above-described problems, it is an object of the present invention to provide a scaling apparatus and method for zooming in or out a video or graphic window. Particularly, an apparatus and method for reducing the internal memory size of a scaler for zooming in or out a video or graphic window is proposed to cope with the present mobile environment.

According to an aspect of the present invention, a serial scaling apparatus includes a source data input unit to which source data is input; a serial output unit serially outputting display data included in the source data; a scaling unit scaling the serially output display data according to a scaling ratio included in the source data; and a scaled display data output unit outputting the scaled display data.

According to another aspect of the present invention, a parallel scaling apparatus includes a source data input unit to which source data is input; a parallel output unit parallelly outputting display data included in the source data; a scaling unit scaling the parallelly output display data according to a scaling ratio included in the source data; and a scaled display data output unit outputting the scaled display data.

### BRIEF DESCRIPTION OF THE DRAWINGS

The above object and advantages of the present invention will become more apparent by describing in detail preferred embodiments thereof with reference to the attached drawings in which:

FIG. 1 is a configuration view of a serial scaling apparatus according to the present invention;

FIG. 2 is a configuration view of an apparatus for serially scaling graphic data of 8 bits according to the present invention;

FIG. 3 is a configuration view of a parallel scaling apparatus according to the present invention;

FIG. 4 is a configuration view of an apparatus for parallelly scaling graphic data of 8 bits according to the present invention;

FIG. 5 is a flowchart of a serial scaling method according to the present invention;

FIG. 6 is a flowchart of a method for serially scaling graphic data of 8 bits according to the present invention;

FIG. 7 is a flowchart of a parallel scaling method according to the present invention; and

FIG. 8 is a flowchart of a method for parallelly scaling graphic data of 8 bits according to the present invention.

### DETAILED DESCRIPTION OF THE INVENTION

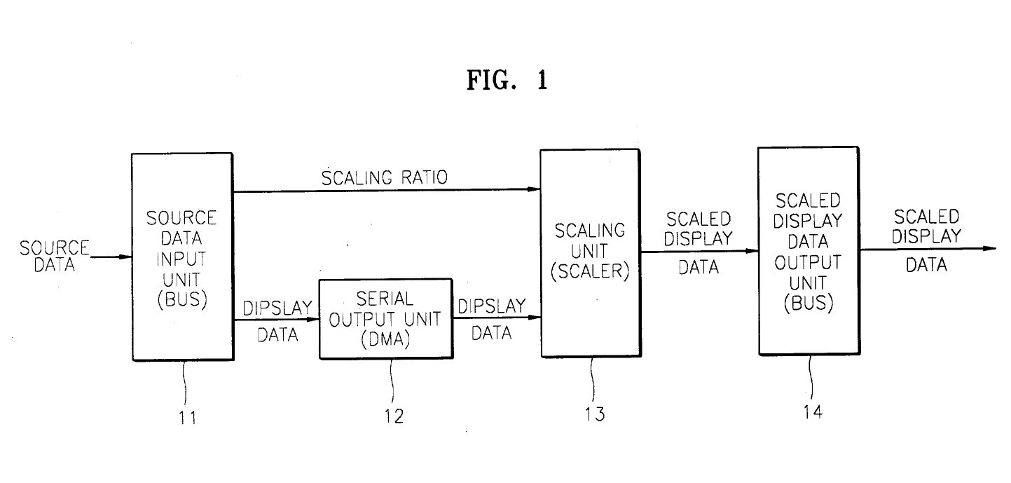

In FIG. 1, which is a configuration view of an apparatus for serially scaling a video data or graphic data of 16 bits according to the present invention, the serial scaling apparatus includes a source data input unit 11, a serial output unit 12, a scaling unit 13 and a scaled display data output unit 14.

Source data is input to the source data input unit 11. The source data can be input to the source data input unit 11 from a system memory. Generally, the system memory is referred to as a random access memory (RAM), which is a workspace memory in a personal computer (PC). The RAM stores display data representing a window of an original size, that is, the display data which a user is coding, when the user zooms in or out the window of the PC using a mouse or cursor, and a scaling ratio corresponding to the zooming in or out of the window, that is, the scaling ratio which the user sets. Further, the source data can be input to the source data input unit 11 from an external memory device. Generally, the external memory device is referred to as a video RAM for storing an image, which is input by a camera. The video RAM stores display data representing a window of an original size, when a user zooms in or out the window of the camera using the mouse or cursor, and a scaling ratio corresponding to the zooming in or out of the window, that is, the scaling ratio which the user sets.

The serial output unit 12 serially outputs display data included in the source data. The scaling unit 13 scales the serially output display data according to a scaling ratio included in the source data. The scaled display data output unit 14 outputs the scaled display data.

In the case that the display data is video data including a Y luminance signal, a Cb color difference signal and a Cr color difference signal, the serial output unit 12 outputs any one signal of the Y luminance signal, the Cb color difference signal and the Cr color difference signal included in the video data in a direct memory access (DMA) manner. The DMA manner means that data is directly transmitted between a memory device and an input/output device without passing through a central processing unit (CPU). If the video data is loaded on a bus, only one signal of the Y luminance signal, the Cb color difference signal or the Cr color difference signal is serially output from the bus in sequence of a bit row of the video data.

The scaling unit 13 scales the predetermined bits of the Y luminance signal, the Cb color difference signal or the Cr color difference signal included in the video data in the vertical direction, and then, scales them in the horizontal direction. The present invention can support a Y luminance signal, a Cb color difference signal or a Cr color difference signal in various types of video formats, for example, 4:4:4, 4:2:0, 4:1:1 or 4:2:2. The reason is because each of the above video formats is stored in respective different memory areas, and after reading the Y luminance signal, the Cb color difference signal or the Cr color difference signal from each of the above video formats in the DMA manner, the Y luminance signal, the Cb color difference signal or the Cr color difference signal is scaled. The above 4:4:4, 4:2:0, 4:1:1 or 4:2:2 indicates a ratio of a sampling frequency used in digitizing a luminance signal (Y) and a color difference signal (R-Y, B-Y) of a component video signal. Herein, the component video signal is a compressed image signal. When digitizing the luminance signal (Y) and the color difference signal (R-Y, B-Y), which are analogue signals, the luminance signal (Y) is represented as a Y luminance signal and the color difference signal (R-Y, B-Y) is represented as a Cb color difference signal or Cr color difference signal. The above 4:1:1 ratio means that, when setting a sampling frequency of a luminance signal (Y) having a frequency of 13.5 MHz to 4, each sampling frequency of a color difference signal (R-Y) and color difference signal (B-Y) is 3.37 MHz, which corresponds to ¼ of the sampling frequency of the luminance signal (Y). The above 4:2:2 ratio means that when sampling a frequency of a luminance signal (Y) four times, frequencies of a color difference signal (R-Y) and a color difference signal (B-Y) are sampled twice. That is, a bandwidth of the color difference signal to the luminance in the above 4:2:2 ratio is larger than that of the above 4:1:1 ratio. While a color resolution of a vertical line corresponds to ½ of that of a horizontal line in the above 4:2:2 ratio, a color resolution of the vertical line is the same as that of a horizontal line in the above 4:2:0. Since ratios regarding both the horizontal direction output and vertical direction output according to each input format can be calculated in the above 4:2:2 and 4:2:0 ratios, flexibility of the input formats is increased.

In the case that the display data is graphic data of 16 bits including an R color signal, a G color signal and a B color signal, the serial output unit 12 outputs any one signal of the R, G and B color signals included in the graphic data of 16 bits in a DMA manner. The scaling unit 13 scales the predetermined bits of the R, G or B color signals included in the graphic data of 16 bits in the vertical direction, and then, scales them in the horizontal direction. Specifically, the serial output unit 12 outputs the graphic data of 16 bits, which are read directly, as the R, G and B color signals of each 8 bits in total of 24 bits through a internal padding in the DMA manner. The scaling unit 13 scales the predetermined bits of the R, G or B color signals included in the graphic data of 16 bits in the vertical direction and stores them in a scaler memory on the vertical direction, and then, after reading them three times from a pingpong memory of the DMA in the above vertical direction, the scaling unit 13 scales them in the horizontal direction and stores them in a scaler memory on the horizontal direction. In the above-described case, in order to reduce at minimum the memory size, the R, G and B color signals included in the graphic data of 16 bits are stored in a 5,6,5 or 5,5,5 pattern of 16 bpp (bits per pixel). In the above-described case, the scaler memory on the vertical direction has a internal static RAM (SRAM) and needs one line memory of the memory size equal to one (1) line size*(24/16)*8. Thus, the internal memory size of the serial scaling is smaller than that of the parallel scaling.

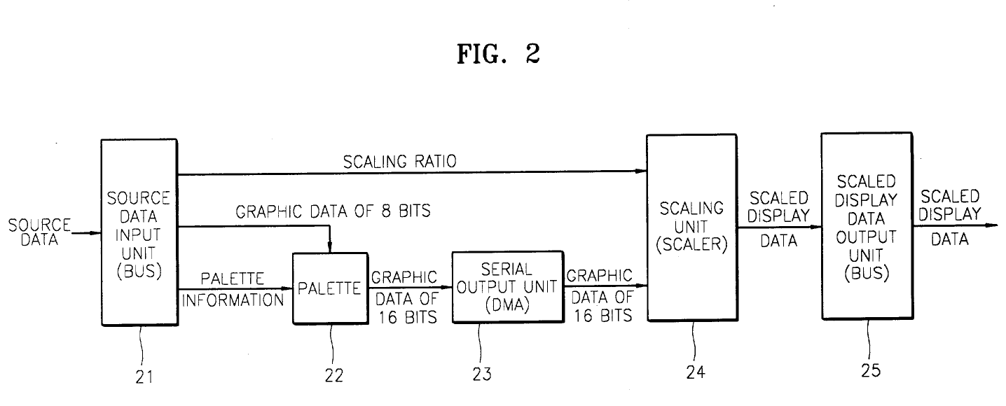

FIG. 2 is a configuration view of an apparatus for serially scaling graphic data of 8 bits according to the present invention.

The apparatus for serially scaling graphic data of 8 bits includes a source data input unit 21, a palette 22, a serial output unit 23, a scaling unit 24 and a scaled display data output unit 25.

Source data is input to the source data input unit 21. The serial output unit 23 serially outputs display data included in the source data. The scaling unit 24 scales the serially output display data according to a scaling ratio included in the source data. The scaled display data output unit 25 outputs the scaled display data.

In the case that the display data is graphic data of 8 bits including an R color signal, a G color signal and a B color signal, the serial output unit 23 generates graphic data of 16 bits by corresponding the graphic data of 8 bits to the palette 22 which is constructed by palette information included in the source data and outputs any one signal of the R, G and B color signals included in the graphic data of 16 bits in a DMA manner. The scaling unit 24 scales the predetermined bits of the R, G or B color signals included in the graphic data of 16 bits in the vertical direction, and then, scales them in the horizontal direction.

The serial output unit 23 outputs the graphic data of 8 bits, which are read directly, as the R, G and B color signals of each 8 bits in total of 24 bits through the palette 22 in a DMA manner. The palette 22 is referred to as a look-up table corresponding to various colors, which are expressed on a computer monitor. When one pixel is displayed on a screen, the color to be displayed is determined by a color bit of the pixel, and it is determined whether the color is displayed directly or indirectly according to the number of the color bit. In the case of indirectly displaying the color, the palette is required. The scaling unit 24 scales a row of 24 bits including the R, G and B color signals in the vertical direction and stores them in a scaler memory on the vertical direction. And then, after reading the row of 24 bits including the R, G and B color signals three times from pingpong memory of the DMA in the above vertical direction, the scaling unit 24 scales them in the horizontal direction and stores them in a scaler memory on the horizontal direction. In the above-described case, in order to reduce at minimum the memory size, the R, G and B color signals included in the graphic data of 16 bits are stored in a 5,6,5 or 5,5,5 pattern of 16 bpp. In the above-described case, the scaler memory on the vertical direction has a internal SRAM and needs one line memory of the memory size equal to one line size*(24/16)*8. Thus, the internal memory size of the serial scaling is smaller than that of the parallel scaling.

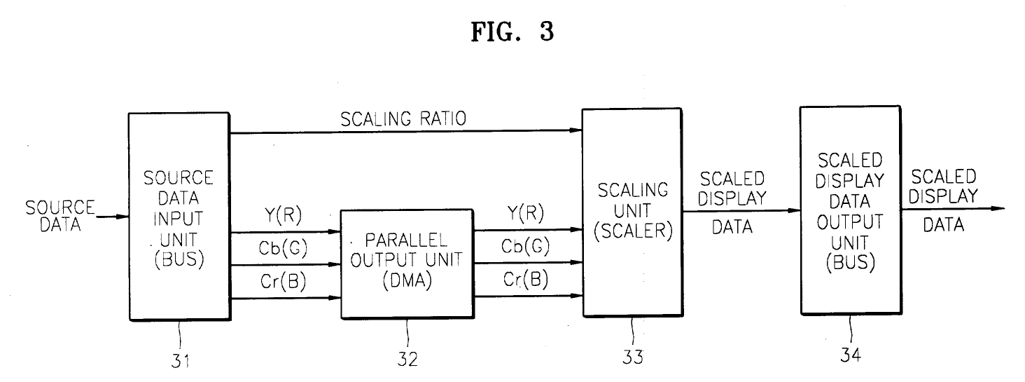

FIG. 3 is a configuration view of an apparatus for parallelly scaling video data or graphic data of 16 bits according to the present invention.

The parallel scaling apparatus includes a source data input unit 31, a parallel output unit 32, a scaling unit 33 and a scaled display data output unit 34.

Source data is input to the source data input unit 31. The source data can be input to the source data input unit 31 from a system memory. Generally, the system memory is referred to as a RAM which is a workspace memory in a PC. The RAM stores display data representing a window of an original size, that is, the display data which a user is coding, when the user zooms in or out the window of the PC using a mouse or cursor, and a scaling ratio corresponding to the zooming in or out of the window, that is, the scaling ratio which the user sets. Further, the source data can be input to the source data input unit 31 from an external memory device. Generally, the external memory device is referred to as a video RAM for storing an image, which is input by a camera. The video RAM stores display data representing a window of an original size, when the user zooms in or out the window of the camera using a mouse or cursor, and a scaling ratio corresponding to the zooming in or out of the window, that is, the scaling ratio which the user sets.

The parallel output unit 32 parallelly outputs display data included in the source data. The scaling unit 33 scales the parallelly output display data according to a scaling ratio included in the source data. The scaled display data output unit 34 outputs the scaled display data.

In the case that the display data is video data including a Y luminance signal, a Cb color difference signal and a Cr color difference signal, the parallel output unit 32 simultaneously outputs the Y luminance signal, the Cb color,difference signal and the Cr color difference signal included in the video data in a DMA manner. In the DMA manner, if the video data is loaded on a bus, each bit row of the Y luminance signal, the Cb color difference signal and the Cr color difference signal included in the video data is simultaneously output in parallel.

The scaling unit 33 simultaneously scales the predetermined bits of the Y luminance signal, the Cb color difference signal, and the Cr color difference signal included in the video data in the vertical direction, and then, simultaneously scales them in the horizontal direction. The present invention can support a Y luminance signal, a Cb color difference signal or a Cr color difference signal in various types of video formats, for example, 4:4:4, 4:2:0, 4:1:1 or 4:2:2. The reason is because, each of the above video formats is stored in respective different memory areas, and then, after reading a Y luminance signal, a Cb color difference signal or a Cr color difference signal from each of the above video formats in a DMA manner, the Y luminance signal, the Cb color difference signal or the Cr color difference signal are scaled. In the above-described case, since ratios of the memory size of both the horizontal direction output and the vertical direction output according to each input formats can be calculated, flexibility of the input formats can be increased.

In the case that the display data is graphic data of 16 bits including a R color signal, a G color signal and a B color signal, the parallel output unit 32 simultaneously outputs the R, G and B color signals included in the graphic data of 16 bits in a DMA manner. The scaling unit 33 scales the predetermined bits of the R, G and B color signals included in the graphic data of 16 bits in the vertical direction, and then, scales them in the horizontal direction. Specifically, the parallel output unit 32 outputs the graphic data of 16 bits, which are read directly, as the R, G and B color signals of each 8 bits in total of 24 bits through a internal padding in the DMA manner. The scaling unit 33 simultaneously scales the R, G and B color signals of each 8 bits in the vertical direction and stores them in a scaler memory on the vertical direction, and then, after reading them three times from a pingpong memory of the DMA in the above vertical direction, the scaling unit 33 simultaneously scales the R, G and B color signals of each 8 bits in the horizontal direction and stores them in a scaler memory on the horizontal direction. The parallel scaling apparatus of FIG. 3 is not different from the conventional parallel scaling apparatus in the internal memory size. However, since the parallel scaling apparatus of FIG. 3 is embodied not in software but in hardware, the parallel scaling apparatus of FIG. 3 is not controlled by a CPU. As a result, the scaling speed is increased.

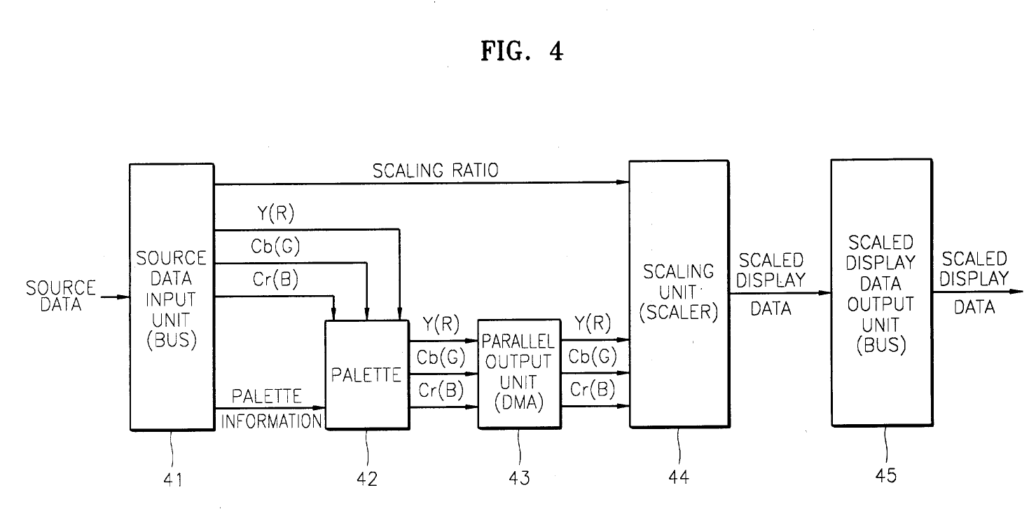

FIG. 4 is a configuration view of an apparatus for parallelly scaling graphic data of 8 bits according to the present invention.

The apparatus for parallelly scaling graphic data of 8 bits includes a source data input unit 41, a palette 42, a parallel output unit 43, a scaling unit 44 and a scaled display data output unit 45.

Source data is input to the source data input unit 41. The parallel output unit 43 parallelly outputs the display data included in the source data. The scaling unit 44 scales the parallelly output display data according to a scaling ratio included in the source data. The scaled display data output unit 45 outputs the scaled display data.

In the case that the display data is graphic data of 8 bits including a R color signal, a G color signal and a B color signal, the parallel output unit 43 generates graphic data of 16 bits by corresponding the graphic data of 8 bits to the palette 42 which is constructed by palette information included in the source data and simultaneously outputs the R, G and B color signals included in the graphic data of 16 bits in a DMA manner. The scaling unit 44 simultaneously scales the predetermined bits of the R, G and B color signals included in the graphic data of 16 bits, for example, by the 8 bits regarding each signal in the vertical direction, and then, simultaneously scales in the horizontal direction by 8 bits regarding each signal. The serial output unit 43 outputs the graphic data of 8 bits, which are read directly, as the R, G and B color signals of each 8 bits in total of 24 bits through the palette 42 in the DMA manner. The scaling unit 44 simultaneously scales a row of 24 bits including the R, G and B color signals in the vertical direction by the 8 bits and stores them in a scaler memory on the vertical direction. And then, after reading the row of 24 bits including the R, G and B color signals in the vertical direction by the 8 bits three times from a pingpong memory of the DMA in the above vertical direction, the scaling unit 13 simultaneously scales them in the horizontal direction by the 8 bits and stores them in a scaler memory on the horizontal direction. The parallel scaling apparatus of FIG. 4 is not different from the conventional parallel scaling apparatus in the internal memory size. However, since the parallel scaling apparatus of FIG. 4 is embodied not in software but in hardware, the parallel scaling apparatus of FIG. 4 is not controlled by a CPU. As a result, the scaling speed is increased.

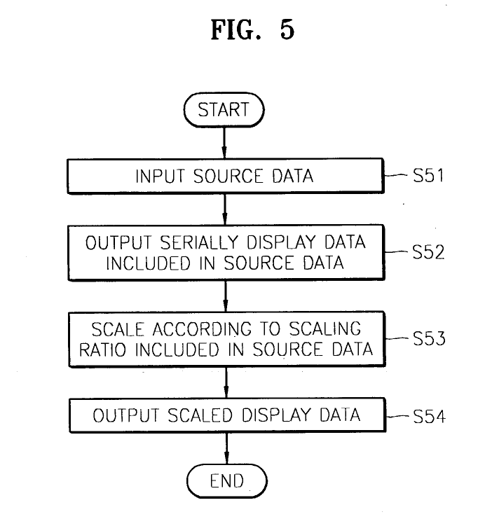

FIG. 5 is a flowchart of a serial scaling method according to the present invention.

First, source data is input (step S51). The source data may be input from a system memory or an external memory device. The system memory stores display data representing a window of an original size on a PC and a scaling ratio corresponding to the zooming or out of the window set by a user. The external memory device stores display data representing a window of an original size on a camera and a scaling ratio corresponding to the zooming or out of the window set by the user. Next, the display data included in the source data is serially output (step S52). And then, the serially output display data of the source data is scaled according to a scaling ratio included in the source data (step S53). Finally, the scaled display data is output (step S55).

In the case that the display data is video data including a Y luminance signal, a Cb color difference signal and a Cr color difference signal, in the step 52, any one signal of the Y luminance signal, the Cb color difference signal and the Cr color difference signal included in the video data is output in a DMA manner. Next, in the step S53, the predetermined bits of the Y luminance signal, the Cb color difference signal or the Cr color difference signal of the video data are scaled in the vertical direction, and then, are scaled in the horizontal direction.

In the case that the display data is graphic data of 16 bits including a R color signal, a G color signal and a B color signal, in the step S52, any one signal of the R, G and B color signals included in the graphic data of 16 bits is output in a DMA manner. Next, in the step S53, the predetermined bits of the R, G or B color signals included in the graphic data of 16 bits are scaled in the vertical direction, and then, are scaled in the horizontal direction.

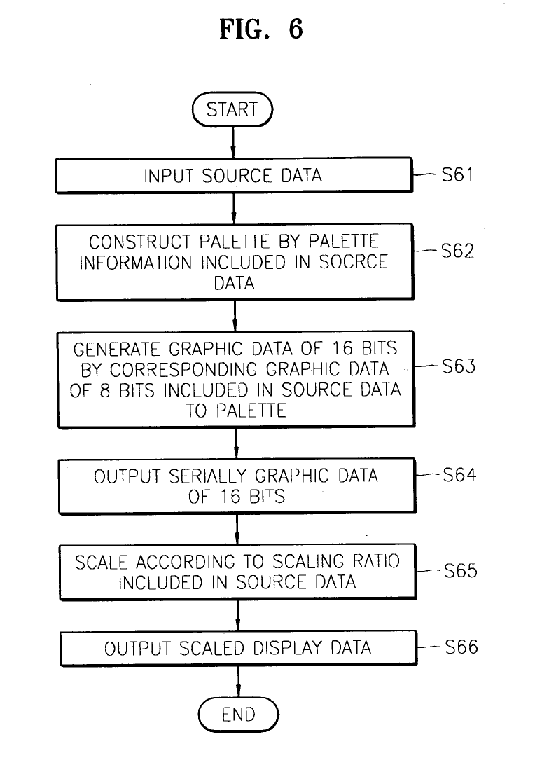

FIG. 6 is a flowchart of a method for serially scaling graphic data of 8 bits according to the present invention.

First, source data is input (step S61). Next, a palette is constructed based on palette information included in the source data (step S62). Next, graphic data of 16 bits is generated by corresponding the graphic data of 8 bits included in the source data to the palette (step S63). Any one signal of the R, G and B color signals included in the graphic data of 16 bits is output in a DMA manner (step S64). Next, the serially output display data is scaled according to a scaling ratio included in the source data (step S65). That is, the predetermined bits of the R, G or B color signals of the graphic data of 16 bits are scaled in the vertical direction, and then, are scaled in the horizontal direction. Finally, the scaled display data is output (step S66).

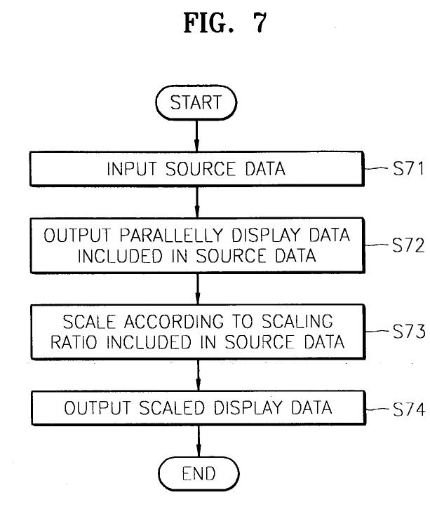

FIG. 7 is a flowchart of a method for parallelly scaling video data or graphic data of 16 bits according to the present invention.

First, source data is input (step S71). The source data may be input from a system memory. The system memory stores display data representing a window of an original size on a PC and a scaling ratio corresponding to the zooming or out of the window set by a user. Further, the source data may be input from an external memory device. The external memory device stores display data representing a window of an original size on a camera and a scaling ratio corresponding to the zooming or out of the window set by the user. Next, the display data included in the source data is parallelly output (step S72). And then, the parallelly output display data is scaled according to a scaling ratio included in the source data (step S73). Next, the scaled display data is output (step S74).

In the case that the display data is video data including a Y luminance signal, a Cb color difference signal and a Cr color difference signal, in the step S72, the Y luminance signal, the Cb color difference signal and the Cr color difference signal included in the video data is simultaneously output in a DMA manner. Next, in the step S73, the predetermined bits of the Y luminance signal, the Cb color difference signal and the Cr color difference signal of the video data are scaled in the vertical direction, and then, are scaled in the horizontal direction.

In case that the display data is graphic data of 16 bits including a R color signal, a G color signal and a B color signal, in the step S72, the R, G and B color signals included in the graphic data of 16 bits are simultaneously output in the DMA manner. Next, in the step S73, the predetermined bits of the R, G and B color signals included in the graphic data of 16 bits are scaled in the vertical direction, and then, are scaled in the horizontal direction.

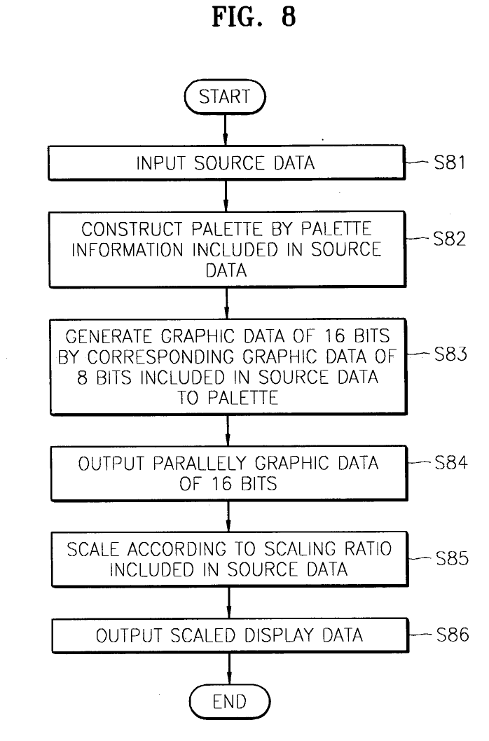

FIG. 8 is a flowchart of a method for parallelly scaling graphic data of 8 bits according to the present invention.

First, source data is input (step S81). Next, a palette is constructed based on palette information included in the source data (step S82). Next, graphic data of 16 bits are generated by corresponding the graphic data of 8 bits included in the source data to the palette (step S83). A R color signal, a G color signal and a B color signal included in the graphic data of 16 bits are simultaneously output in a DMA manner (step S84). Next, the parallelly output display data is scaled according to a scaling ratio included in the source data (step S85). That is, the predetermined bits of the R, G and B color signals included in the graphic data of 16 bits are scaled in the vertical direction, and then, are scaled in the horizontal direction. Finally, the scaled display data is output (step S86).

The above-described embodiments of the present invention can be created as a program, which can be executed on a computer, and can be embodied though a general digital computer for operating the above program using a computer readable recording medium.

The computer readable recording medium includes a storing medium such as a magnetic storing medium (for example, ROM, floppy disc, hard disc), a optical reading medium (for example, CDROM, DVD) and a carrier wave (for example, transmission through internet).

According to the present invention, the scaling speed is increased by processing the application for zooming in or out the video or graphic window in hardware. Further, 8 bpp graphic data is effectively processed without using depalette. Particularly, according to the serial scaling apparatus and method of the present invention, the internal memory size of the scaler is reduced by the serial scaling. In addition, scaling on desktop can be carried out under the mobile environment which is small and lightweight.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A serial scaling apparatus comprising:
a source data input unit to which source data is input;
a serial output unit which receives from the source data input unit display data included in the source data and serially outputs the display data;
a scaling unit which receives from said serial output unit the display data, and receives from the source data input unit a scaling ratio included in the source data, and scales the display data according to the scaling ratio; and
a scaled display data output unit which receives from the scaling unit the scaled display data and outputs the scaled displayed data.

2. The apparatus of claim 1, wherein the source data is input to the source data input unit from a system memory.

3. The apparatus of claim 2, wherein the system memory stores the display data which represents a window on a personal computer (PC) and a scaling ratio set by a user.

4. The apparatus of claim 1, wherein the source data is input to the source data input unit from an external memory device.

5. The apparatus of claim 4, wherein the external memory device stores the display data which represents a window on a camera and a scaling ratio set by a user.

6. The apparatus of claim 1, wherein the display data comprises video data including a Y luminance signal, a Cb color difference signal and a Cr color difference signal.

7. The apparatus of claim 6, wherein the serial output unit outputs one signal of the Y luminance signal, the Cb color difference signal and the Cr color difference signal included in the video data in a direct memory access (DMA) manner.

8. The apparatus of claim 7, wherein the scaling unit scales the predetermined bits of the Y luminance signal, the Cb color difference signal or the Cr color difference signal included in the video data in the vertical direction, and then in the horizontal direction.

9. The apparatus of claim 1, wherein the display data comprises graphic data of 16 bits including an R color signal, a G color signal and a B color signal.

10. The apparatus of claim 9, wherein the serial output unit outputs one signal of the R, G and B color signals included in the graphic data of 16 bits in a direct memory access (DMA) manner.

11. The apparatus of claim 10, wherein the scaling unit scales the predetermined bits of the R, G or B color signals included in the graphic data of 16 bits in the vertical direction, and then in the horizontal direction.

12. The apparatus of claim 1, wherein the display data is graphic data of 8 bits including an R color signal, a G color signal and a B color signal.

13. The apparatus of claim 12, wherein the serial output unit generates graphic data of 16 bits by corresponding the graphic data of 8 bits to a palette which is constructed by palette information included in the source data and outputs one signal of the R, G and B color signals included in the graphic data of 16 bits in a direct memory access (DMA) manner.

14. The apparatus of claim 13, wherein the scaling unit scales the predetermined bits of the R, G and B color signals included in the graphic data of 16 bits in the vertical direction, and then in the horizontal direction.

15. A parallel scaling apparatus comprising:
a source data input unit to which source data is input;
a parallel output unit which receives from the source data input unit display data included in the source data and parallelly outputs the display data;
a scaling unit which receives from the parallel output unit the display data, receives from the source data input unit a scaling ratio included in the source data, and scales the display data according to the scaling ratio; and
a scaled display data output unit which receives from the scaling unit the scaled displayed data and outputs the scaled display data.

16. The apparatus of claim 15, wherein the source data is input to the source data input unit from a system memory.

17. The apparatus of claim 16, wherein the system memory stores the display data which represents a window on a personal computer (PC) and a scaling ratio set by a user.

18. The apparatus of claim 15, wherein the source data is input to the source data input unit from an external memory device.

19. The apparatus of claim 18, wherein the external memory device stores the display data which represents a window on a camera and a scaling ratio set by a user.

20. The apparatus of claim 15, wherein the display data comprises video data including a Y luminance signal, a Cb color difference signal and a Cr color difference signal.

21. The apparatus of claim 20, wherein the parallel output unit simultaneously outputs the Y luminance signal, the Cb color difference signal and the Cr color difference signal included in the video data in a direct memory access (DMA) manner.

22. The apparatus of claim 21, wherein the scaling unit scales the predetermined bits of the Y luminance signal, the Cb color difference signal and the Cr color difference signal included in the video data in the vertical direction, and then in the horizontal direction.

23. The apparatus of claim 15, wherein the display data comprises graphic data of 16 bits including an R color signal, a G color signal and a B color signal.

24. The apparatus of claim 23, wherein the parallel output unit simultaneously outputs the R, G and B color signals included in the graphic data of 16 bits in a direct memory access (DMA) manner.

25. The apparatus of claim 24, wherein the scaling unit scales the predetermined bits of the R, G and B color signals included in the graphic data of 16 bits in the vertical direction, and then in the horizontal direction.

26. The apparatus of claim 15, wherein the display data comprises graphic data of 8 bits including an R color signal, a G color signal and B color signal.

27. The apparatus of claim 26, wherein the parallel output unit generates graphic data of 16 bits by corresponding the graphic data of 8 bits to a palette which is constructed by palette information included in the source data and simultaneously outputs the R, G and B color signals included in the graphic data of 16 bits in a direct memory access (DMA) manner.

28. The apparatus of claim 27, wherein the scaling unit scales the predetermined bits of the R, G and B color signals included in the graphic data of 16 bits in the vertical direction, and then in the horizontal direction.

29. A serial scaling method comprising the steps of:
(a) inputting source data;
(b) serially outputting display data included in the source data;
(c) scaling the serially output display data according to a scaling ratio included in the source data; and
(d) outputting the scaled display data.

30. The method of claim 29, wherein in step (a), the source data is input from a system memory.

31. The method of claim 30, wherein the system memory stores the display data which represents a window on a personal computer (PC) and a scaling ratio set by a user.

32. The method of claim 29, wherein in step (a), the source data is input from an external memory device.

33. The method of claim 32, wherein the external memory device stores display data representing a window on a camera and a scaling ratio set by a user.

34. The method of claim 29, wherein the display data is video data including a Y luminance signal, a Cb color difference signal and a Cr color difference signal.

35. The method of claim 34, wherein in step (b), any one signal of the Y luminance signal, the Cb color difference signal or the Cr color difference signal of the video data is output in a DMA manner.

36. The method of claim 35, wherein in step (c), the predetermined bits of the Y luminance signal, the Cb color difference signal or the Cr color difference signal included in the video data are scaled in the vertical direction, and then, are scaled in the horizontal direction.

37. The method of claim 29, wherein the display data is graphic data of 16 bits including an R color signal, a G color signal and a B color signal.

38. The method of claim 37, wherein in step (b), any one signal of the R, G or B color signals included in the graphic data of 16 bits is output in the DMA manner.

39. The method of claim 38, wherein in step (c), the predetermined bits of the R, G or B color signals included in the graphic data of 16 bits are scaled in the vertical direction, and then, are scaled in the horizontal direction.

40. The method of claim 29, wherein the display data is graphic data of 8 bits including an R color signal, a G color signal and a B color signal.

41. The method of claim 40, wherein in step (b), graphic data of 16 bits are generated by corresponding the graphic data of 8 bits to a palette which is constructed by palette information included in the source data and any one signal of the R, G or B color signals included in the graphic data of 16 bits is output in the DMA manner.

42. The method of claim 41, wherein in step (c), the predetermined bits of the R, G or B color signals included in the graphic data of 16 bits are scaled in the vertical direction, and then, are scaled in the horizontal direction.

43. A parallel scaling method comprising the steps of:
(a) inputting source data;
(b) parallelly outputting display data included in the source data;
(c) scaling the parallelly output display data according to a scaling ratio included in the source data; and
(d) outputting the scaled display data.

44. The method of claim 43, wherein in step (a), the source data is input from a system memory.

45. The method of claim 44, wherein the system memory stores display data representing a window on a personal computer (PC) and a scaling ratio set by a user.

46. The method of claim 43, wherein in step (a), the source data is input from an external memory device.

47. The method of claim 46, wherein the external memory device stores the display data which represents a window on a camera and a scaling ratio set by a user.

48. The method of claim 43, wherein the display data is video data including a Y luminance signal, a Cb color difference signal and a Cr color difference signal.

49. The method of claim 48, wherein in step (b), the Y luminance signal, the Cb color difference signal and the Cr color difference signal included in the video data are simultaneously output in a direct memory access (DMA) manner.

50. The method of claim 49, wherein in step (c), the predetermined bits of the Y luminance signal, the Cb color difference signal or the Cr color difference signal included in the video data are scaled in the vertical direction, and then, are scaled in the horizontal direction.

51. The method of claim 43, wherein the display data comprises graphic data of 16 bits including an R color signal, a G color signal and B color signal.

52. The method of claim 51, wherein in step (b), the R, G and B color signals of the graphic data of 16 bits are simultaneously output in a direct memory access (DMA) manner.

53. The method of claim 52, wherein in step (c), the predetermined bits of the R, G and B color signals included in the graphic data of 16 bits are scaled in the vertical direction, and then, are scaled in the horizontal direction.

54. The method of claim 43, wherein the display data comprises graphic data of 8 bits including an R color signal, a G color signal and a B color signal.

55. The method of claim 54, wherein in step (b), graphic data of 16 bits are generated by corresponding the graphic data of 8 bits to a palette which is constructed by palette information included in the source data and the R, G and B color signals included in the graphic data of 16 bits are simultaneously output in a direct memory access (DMA) manner.

56. The method of claim 55, wherein in step (c), the predetermined bits of the R, G and B color signals included in the graphic data of 16 bits are scaled in the vertical direction, and then, are scaled in the horizontal direction.

57. A computer readable recording medium for recording a program for carrying out on a computer a serial scaling method comprising the steps of:
(a) inputting source data;
(b) serially outputting display data included in the source data;
(c) scaling the serially output display data according to a scaling ratio included in the source data; and
(d) outputting the scaled display data.

58. A computer readable recording medium for recording a program for carrying out on a computer a parallel scaling method comprising the steps of:
(a) inputting source data;
(b) parallelly outputting display data included in the source data;
(c) scaling the parallelly output display data according to a scaling ratio included in the source data; and
(d) outputting the scaled display data.
